(19) United States
(12) Patent Application Publication
(10) Pub. No.: US 2005/0106368 A1
(43) Pub. Date: May 19, 2005

(54) Printed circuit board and manufacturing method thereof

(75) Inventors: Sang-Won Ha, Daejeon (KR); Byoung-Ho Rhee, Daejeon (KR); Kyoung-Hwan Lim, Daejeon (KR); Kyoung-Up Shin, Chungcheongbuk-do (KR); Dek-Gin Yang, Chungcheongbuk-do (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/790,191

(22) Filed: Mar. 2, 2004

(30) Foreign Application Priority Data
Nov. 14, 2003 (KR) 2003-80603

(51) Int. Cl. B05D 5/12; B32B 3/00

(52) U.S. Cl. 428/209; 427/96.1; 427/212; 427/372.2; 428/901

(57) ABSTRACT

Disclosed is a PCB in which copper clads are formed on both sides or any one side of a semicured prepreg having a structure that optical fibers disposed at regular intervals by fixing jigs are embedded in an epoxy resin, and a method of producing the same. Furthermore, the present invention provides a PCB, in which copper clads are formed on both sides or any one side of a semicured prepreg having a structure that a waveguide layer to transmit an optical signal therethrough is embedded in an epoxy resin.

### BACKGROUND OF THE INVENTION

1. Field of the Invention

The present invention pertains, in general, to a printed circuit board (PCB) and a method of producing the same and, more particularly, to a PCB in which copper clads are formed on any one side or both sides of a semicured prepreg having a structure that optical fibers disposed at regular intervals by fixing jigs are embedded in an epoxy resin, and a method of producing the same.

Furthermore, the present invention relates to a PCB in which copper clads are formed on both sides or any one side of a prepreg having a structure that a waveguide layer to transmit an optical signal therethrough is embedded in an epoxy resin, and a method of producing the same.

2. Description of the Related Art

Generally, a method of producing a conventional PCB, includes attaching a thin film made of a predetermined metal such as copper to one side of a phenol resin or an epoxy resin dielectric substrate, etching the thin film (the remaining portion of the thin film except for a linear circuit pattern is etched and removed) to form a predetermined circuit, and forming holes through the thin film to mount parts on the substrate.

However, the conventional PCB is disadvantageous in that an electrical signal is limited by the EMS (electro magnetic susceptibility) characteristic due to the noise characteristic during a high-speed switching at a GHz bandwidth. Additionally, the conventional PCB has a difficulty in transmitting a large quantity of data at high speed in conformity to the rapid increase of use of the Internet.

To avoid the above disadvantages of the conventional PCB, an electro-optical circuit board (EOCB) has been developed, in which optical fibers are formed, to receive or transmit signals in form of light using a polymer and the optical fibers.

In the EOCB, electrical and optical signals are all used, and the ultra-high data communication is interfaced by the optical signal. Additionally, a copper circuit pattern is formed in an element to convert the optical signal into the electrical signal to store data and to treat the electrical signal, and a waveguide or an optical fiber is embedded in the EOCB.

Furthermore, the EOCB is applied to a switch and a transceiver of a communication net, a switch and a server of a data communication, a communication device of the aerospace industry and an avionics, a base station of a mobile telephone of a universal mobile telecommunications system (UMTS), or a backplane and a daughter board used in a mainframe/supercomputer.

However, the EOCB is disadvantageous in that when the optical fiber is embedded in the PCB to form the EOCB, the optical fiber is easily bent, thus not desirably transmitting the optical signal therethrough.

Other disadvantages of the EOCB are that the embedding of the optical fiber in the PCB is accompanied with a complicated process, leading to increased production costs and time.

### SUMMARY OF THE INVENTION

Accordingly, the present invention has been made keeping in mind the above problems occurring in the prior art, and an aspect of the present invention is to provide a PCB in which copper clads are formed on any one side or both sides of a semicured prepreg having a structure that optical fibers disposed at regular intervals by fixing jigs are embedded in an epoxy resin, and a method of producing the same.

It is another aspect of the present invention to provide a PCB in which copper clads are formed on both sides or any one side of a prepreg having a structure that a waveguide layer to transmit an optical signal therethrough is embedded in an epoxy resin, and a method of producing the same.

Additional aspects and/or advantages of the invention will be set forth in part in the description which follows and, in part, will be obvious from the description, or may be learned by practice of the invention.

The above and/or other aspects are achieved by providing a prepreg with optical fibers embedded therein, including the optical fibers disposed at regular intervals, and an epoxy resin including the optical fibers embedded therein.

The above and/or other aspects are achieved by providing a PCB with optical fibers embedded therein, which includes a prepreg, and copper clads formed on both sides of the prepreg through a press process. At this time, the prepreg includes the optical fibers disposed at regular intervals, and an epoxy resin having the optical fibers disposed at regular intervals.

The PCB with the optical fibers may include a semicured prepreg, and a copper clad formed on any one side of the semicured prepreg through a press process. At this time, the semicured prepreg includes the optical fibers disposed at regular intervals, and an epoxy resin having the optical fibers disposed at regular intervals.

The above and/or other aspects are achieved by providing a PCB with waveguides embedded therein, including a prepreg, and copper clads formed on both sides of the prepreg with attachment members interposed between the prepreg and the copper clads through a press process. In this regard, the prepreg includes a waveguide layer to transmit an optical signal therethrough and an epoxy resin layer coated on the waveguide layer with an epoxy resin.

Further, the PCB with the waveguides may include a prepreg, and a copper clad formed on any one side of upper and lower sides of the prepreg with an attachment member interposed between the prepreg and the copper clad through a press process. In this regard, the prepreg includes a waveguide layer to transmit an optical signal therethrough and a resin layer to coat the waveguide layer with an epoxy resin.

The above and/or other aspects are achieved by providing a method of producing a PCB, including a first step of disposing optical fibers on fixing jigs at regular intervals, a second step of dipping the fixing jigs including the optical fibers disposed on surfaces thereof in a vessel containing an epoxy resin to embed the optical fibers in the epoxy resin, a third step of separating the fixing jigs from the optical fibers embedded in the epoxy resin, a fourth step of curing the epoxy resin including the optical fibers embedded therein to produce a semicured prepreg, a fifth step of forming copper clads on both sides of the semicured prepreg while aligning the copper clads with the semicured prepreg, and a sixth step of pressing the semicured prepreg and copper clads aligned with each other at predetermined temperature and pressure.

The above and/or other aspects are achieved by providing a method of producing a PCB with optical fibers embedded therein, including a first step of disposing optical fibers on fixing jigs at regular intervals, a second step of dipping the fixing jigs including the optical fibers disposed on surfaces thereof in a vessel containing an epoxy resin to embed the optical fibers in the epoxy resin, a third step of separating the fixing jigs from the optical fibers embedded in the epoxy resin, a fourth step of semidrying the epoxy resin including the optical fibers embedded therein to cure the epoxy resin to produce a semicured prepreg, a fifth step of forming copper clads on any one side of the semicured prepreg while aligning the copper clads with the semicured prepreg, and a sixth step of pressing the semicured prepreg and copper clads aligned with each other at predetermined temperature and pressure.

The above and/or other aspects are achieved by providing a method of producing a PCB with optical fibers embedded therein, including a first step of mounting fixing jigs, including optical fibers disposed at regular intervals thereon, on a copper clad, a second step of coating the optical fibers, disposed at regular intervals on the copper clad using the fixing jigs, with an epoxy resin, a third step of separating the fixing jigs from the optical fibers, and a fourth step of semidrying the epoxy resin coated on the optical fibers to form a semicured prepreg on the copper clad.

The above and/or other aspects are achieved by providing a method of producing a PCB with waveguides embedded therein, including a first step of forming a waveguide layer, having waveguides therein, to transmit an optical signal therethrough, a second step of dipping the waveguide layer into an epoxy resin to form a semicured prepreg, a third step of forming copper clads on the upper and lower sides of the semicured prepreg while aligning the copper clads with the semicured prepreg, and a fourth step of pressing the semicured prepreg and copper clads aligned with each other at predetermined temperature and pressure.

The above and/or other aspects are achieved by providing a method of producing a PCB with waveguides embedded therein, including a first step of forming a waveguide layer, having waveguides therein, to transmit an optical signal therethrough, a second step of dipping the waveguide layer in an epoxy resin to form a prepreg, a third step of forming a copper clad on one side of the semicured prepreg while aligning the copper clad with the prepreg, and a fourth step of pressing the prepreg and copper clad aligned with each other at predetermined temperature and pressure.

### BRIEF DESCRIPTION OF THE DRAWINGS

This and other aspects and advantages of the invention will become apparent and more readily appreciated from the following description of the preferred embodiments, taken in conjunction with the accompanying drawing of which:

FIG. 1 is a sectional view of a prepreg for a PCB according to the present invention;

FIG. 2 is a flow chart illustrating the production of the prepreg for the PCB according to the present invention;

FIGS. 3A to 3E illustrate the production of the prepreg for the PCB according to the present invention;

FIG. 4 is a perspective view of a PCB, including optical fibers embedded therein, according to the first embodiment of the present invention;

FIG. 5 is a flow chart illustrating the production of the PCB, including the optical fibers embedded therein, according to the first embodiment of the present invention;

FIGS. 6A to 6F illustrate the production of the PCB, including the optical fibers embedded therein, according to the first embodiment of the present invention;

FIG. 7 is a perspective view of a PCB, including optical fibers embedded therein, according to the second embodiment of the present invention;

FIG. 8 is a flow chart illustrating the production of the PCB, including the optical fibers embedded therein, according to the second embodiment of the present invention;

FIGS. 9A to 9D illustrate the production of the PCB, including the optical fibers embedded therein, according to the second embodiment of the present invention;

FIG. 10 is a perspective view of a PCB, including waveguides for a large area embedded therein, according to the third embodiment of the present invention;

FIG. 11 is a flow chart illustrating the production of the PCB, including the waveguides for the large area embedded therein, according to the third embodiment of the present invention;

FIG. 12 is a flow chart illustrating the production of a waveguide layer formed in the PCB, including the waveguides for the large area embedded therein, according to the third embodiment of the present invention;

FIGS. 13A to 13I illustrate the production of the PCB, including the waveguides for the large area embedded therein, according to the third embodiment of the present invention;

FIG. 14 is a perspective view of a PCB, including waveguides for a large area embedded therein, according to the fourth embodiment of the present invention;

FIG. 15 is a flow chart illustrating the production of the PCB, including the waveguides for the large area embedded therein, according to the fourth embodiment of the present invention;

FIG. 16 is a flow chart illustrating the production of a waveguide layer formed in the PCB, including the waveguides for the large area embedded therein, according to the fourth embodiment of the present invention; and

FIGS. 17A to 17I illustrate the production of the PCB, including the waveguides for the large area embedded therein, according to the fourth embodiment of the present invention.

### DETAILED DESCRIPTION OF THE PREFERRED EMBODIMENTS

Reference will now be made in detail to the present preferred embodiments of the present invention, examples of which are illustrated in the accompanying drawings.

Hereinafter, a PCB with optical fibers embedded therein according to the present invention and a method of producing the PCB will be described, in more detail, by reference to the accompanying drawings.

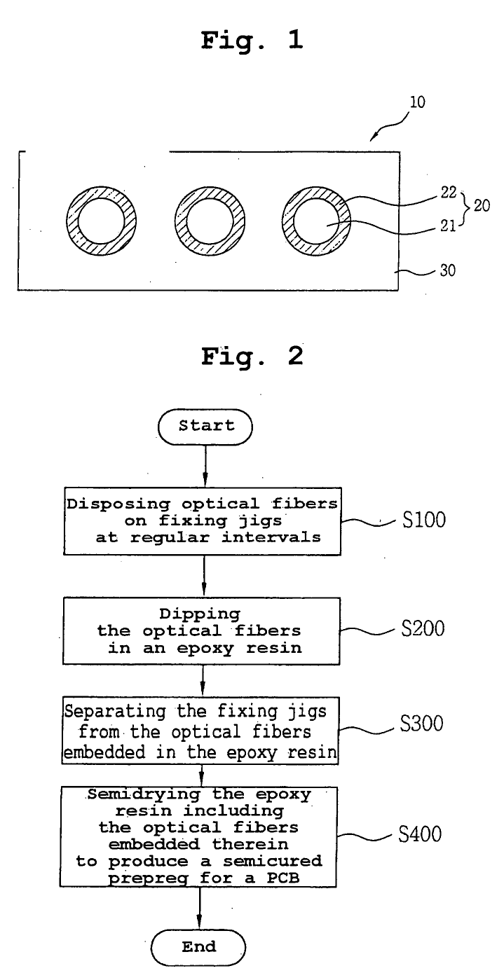

A detailed description will be given of a prepreg for a PCB according to the present invention by reference to the FIGS. 1 to 3E.

With reference to FIG. 1, there is illustrated a sectional view of the prepreg for the PCB according to the present invention. The prepreg 10 of the present invention includes optical fibers 20 each having a core 21 and a clad 22, and an epoxy resin 30 having the optical fibers 20 embedded therein.

The optical fibers 20 produced by spinning a transparent dielectric (or insulator) such as quartz glasses or plastics serve to transmit an optical signal therethrough based on a mechanism that the clad 22 intercepting light has a slightly lower refractivity than the core 21, thereby the light irradiated into the core 21 is repeatedly total-reflected at an interface between the core 21 and clad 22.

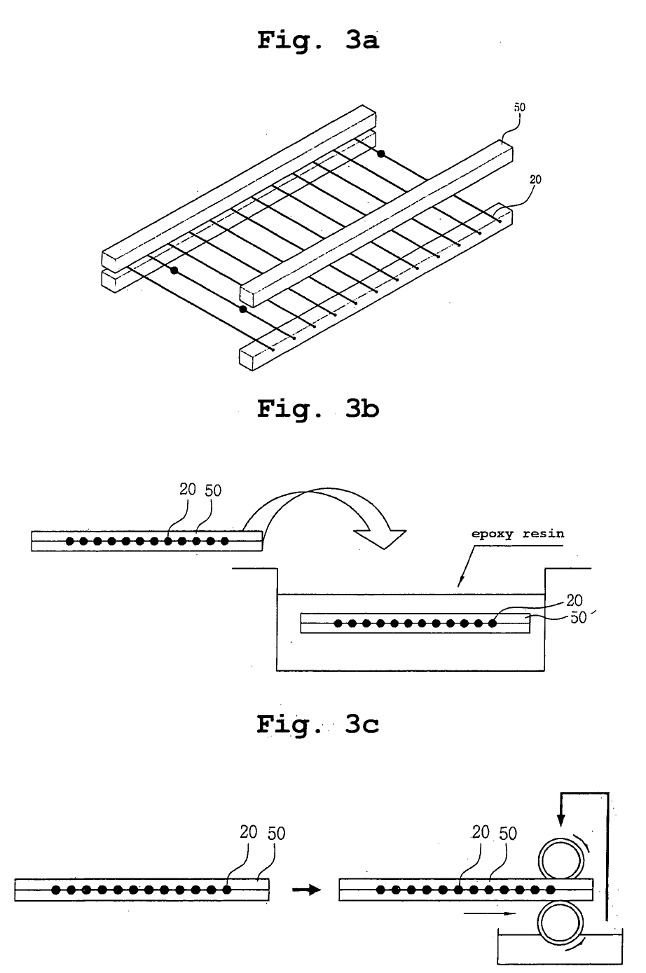

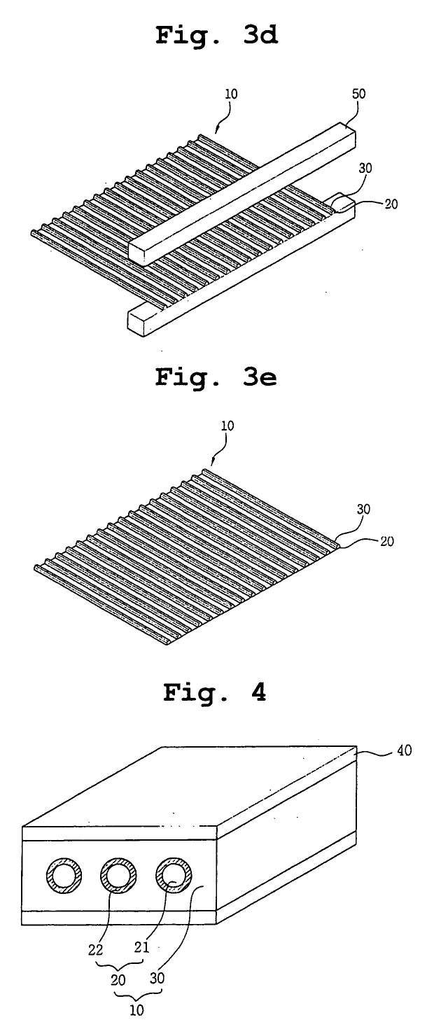

Hereinafter, a detailed description will be given of the production of the prepreg 10 including the optical fibers embedded therein by reference to FIGS. 2 and 3.

With reference to FIG. 3A, the optical fibers 20 are disposed on fixing jigs 50 each having grooves formed on inner surfaces thereof at regular intervals in operation 100.

Referring to FIGS. 3B and 3C, the optical fibers 20 disposed in the fixing jigs 50 are embedded in an epoxy resin 30 according to a predetermined process in operation 200.

In this respect, FIG. 3B illustrates the dipping of the fixing jigs 50 combined with the optical fibers 20 into a vessel containing the epoxy resin 30 to embed the optical fibers 20 in the epoxy resin 30, and FIG. 3C illustrates the rolling of the fixing jigs 50 combined with the optical fibers 20 to embed the optical fibers 20 in the epoxy resin 30. As shown in FIG. 3D, the fixing jigs 50 are separated from the prepreg 10 in operation 300.

As shown in FIG. 3E, the epoxy resin 30 including the optical fibers 20 embedded therein is semidried for a predetermined time, thereby accomplishing the semicured prepreg 10 for the PCB, including the optical fibers 20 embedded in the epoxy resin 30 at regular intervals in operation 400.

Hereinafter, a detailed description will be given of a PCB including optical fibers embedded therein according to the first embodiment of the present invention, and a method of producing the same by reference to FIGS. 4 to 6.

As shown in FIG. 4, the PCB with the optical fibers according to the first embodiment of the present invention comprises a semicured prepreg 10 including the optical fibers 20 each having a core 21 and a clad 22, and an epoxy resin 30 having the optical fibers 20 embedded therein, and copper clads 40 formed on upper and lower sides of the semicured prepreg 10 through a press process.

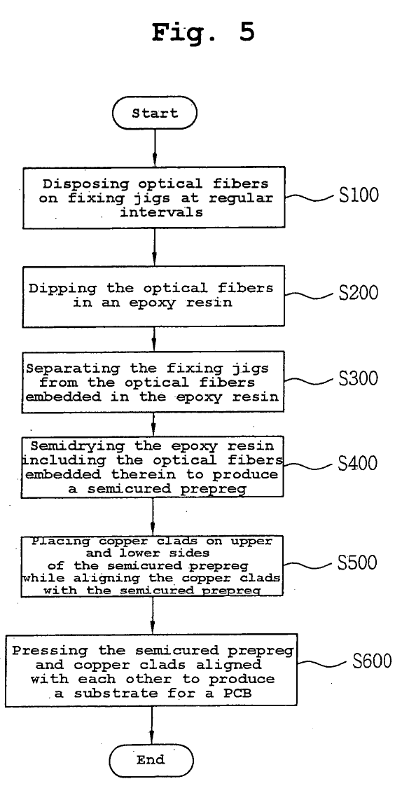

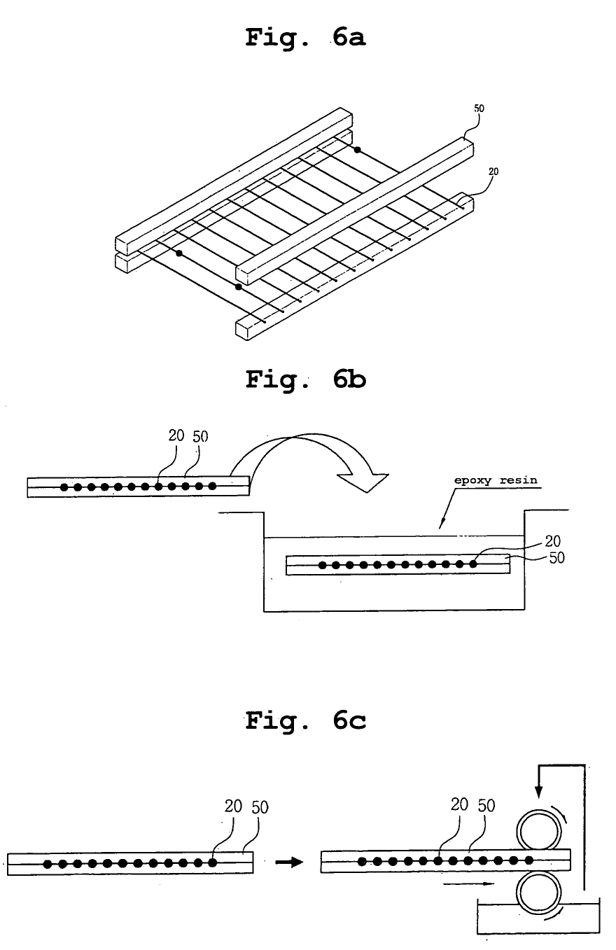

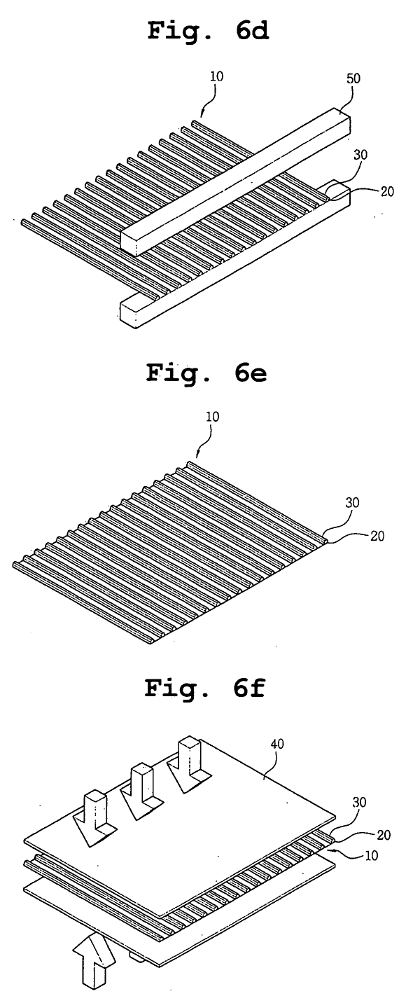

FIG. 5 is a flow chart illustrating the production of the PCB, including the optical fibers embedded therein, according to the first embodiment of the present invention, and FIGS. 6A to 6F are sectional and perspective views illustrating the production of the PCB, including the optical fibers embedded therein, according to the first embodiment of the present invention.

Hereinafter, a detailed description will be given of the production of the substrate for the PCB, including the optical fibers embedded therein, by reference to FIGS. 5 to 6F. In this regard, the production of the prepreg (the operation 100 to 400) will not be described because it is already described with reference to FIGS. 2 and 3.

After the semicured prepreg 10 including the optical fibers 20 embedded therein is formed, as shown in FIG. 6F, the copper clads 40 are aligned with the semicured prepreg 10 in such a way that the semicured prepreg 10 is interposed between the copper clads 40 in operation 500.

The semicured prepreg 10 and copper clads 40 aligned with each other are pressed at predetermined temperature and pressure to form the the PCB, in detail, a copper clad laminate (CCL) in operation 600.

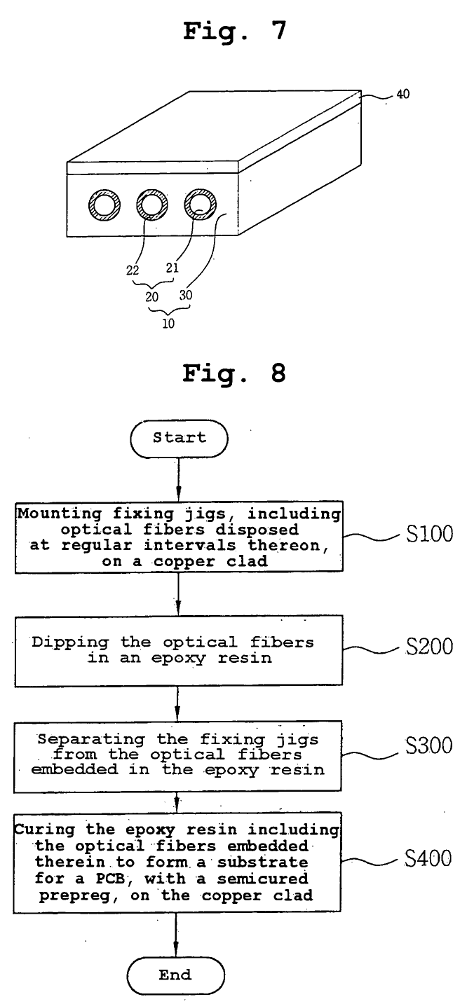

Hereinafter, a detailed description will be given of a PCB including optical fibers embedded therein according to the second embodiment of the present invention, and a method of producing the same, by reference to FIGS. 7 to 9D. In this regard, the PCB includes a copper clad formed on any one side of a prepreg.

Referring to FIG. 7, there is illustrated a perspective view of the PCB, including the optical fibers embedded therein, according to the second embodiment of the present invention.

The PCB with the optical fibers according to the second embodiment of the present invention comprises a semicured prepreg 10, and a copper clad 40 formed on one side of the semicured prepreg 10 as shown in FIG. 7. At this time, the semicured prepreg 10 includes the optical fibers 20 each having a core 21 and a clad 22, and an epoxy resin 30. The optical fibers 20 are embedded in the epoxy resin 30.

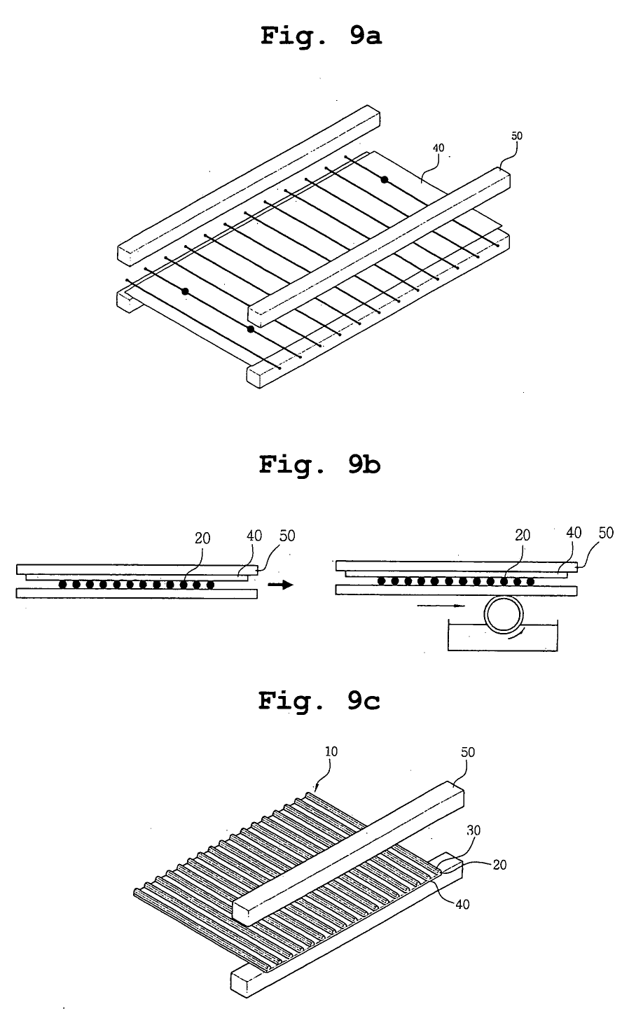

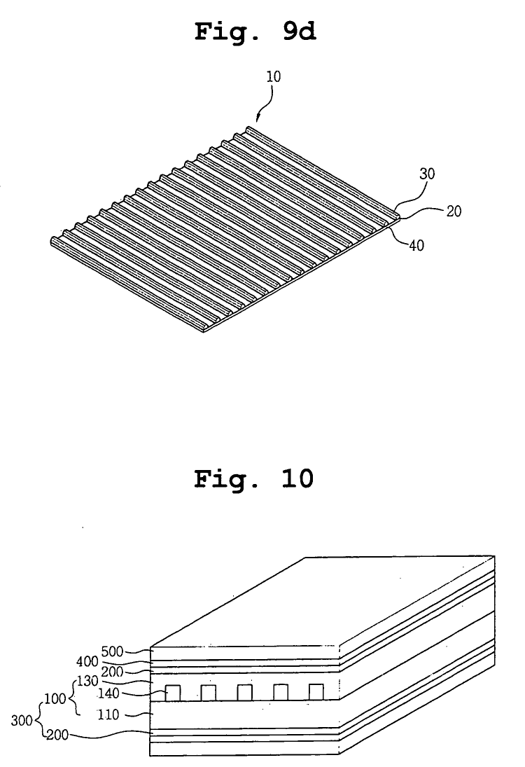

Hereinafter, a detailed description will be given of the production of the PCB with the optical fibers, in which a copper clad is formed on any one side of a prepreg, according to the second embodiment of the present invention, by reference to FIGS. 8 to 9D.

The optical fibers 20 are disposed at regular intervals on the copper clad 40 using fixing jigs 50 in operation 100.

In detail, after the optical fibers 20 are disposed at regular intervals in the fixing jigs 50 having grooves with predetermined shapes on surfaces thereof, the fixing jigs 50 are mounted on the copper clad 40 as shown in FIG. 9A.

Referring to FIG. 9B, the optical fibers 20 disposed at regular intervals in the fixing jigs 50 are coated with an epoxy resin according to a rolling process in operation 200.

After the optical fibers 20 are embedded in the epoxy resin, as shown in FIG. 9C, the fixing jigs 50 are separated from the optical fibers 20 in operation 300.

As shown in FIG. 9D, the epoxy resin 30 is cured for a predetermined time so as to semicure the epoxy resin 30 including the optical fibers 20 embedded therein, thereby accomplishing the PCB having a structure that the semicured prepreg 10 includes the optical fibers 20 and the epoxy resin 30 having the optical fibers 20 embedded therein and the copper clad 40 is formed on one side of the semicured prepreg 10, in detail, a resin-coated copper (RCC) in operation 400.

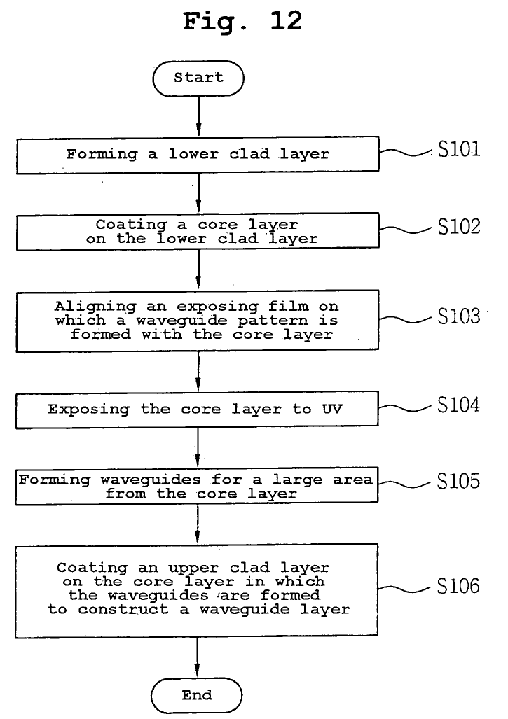

Hereinafter, a detailed description will be given of a PCB including waveguides embedded therein according to the third embodiment of the present invention, and a method of producing the PCB, by reference to FIGS. 10 to 12.

The PCB with the waveguides according to the third embodiment of the present invention comprises a prepreg 300 including a waveguide layer 100 to transmit an optical signal therethrough and epoxy resin layers 200 coated on upper and lower sides of the waveguide layer 100, and copper clads 500 formed on upper and lower sides of the prepreg 300 through a press process while attachment members 400 are interposed between the epoxy resin layers 200 and the copper clads 500 as shown in FIG. 10.

In this regard, the waveguide layer 100 includes a polymeric lower clad layer 110 to conduct a total-reflection of the optical signal irradiated into the waveguide layer 100, a polymeric core layer 120 coated on the lower clad layer 110 to form waveguides 140 with a predetermined shape for a large area on the lower clad layer 110, and a polymeric upper clad layer 130 coated on the core layer 120 to conduct the total-reflection of the optical signal irradiated into the waveguide layer 100.

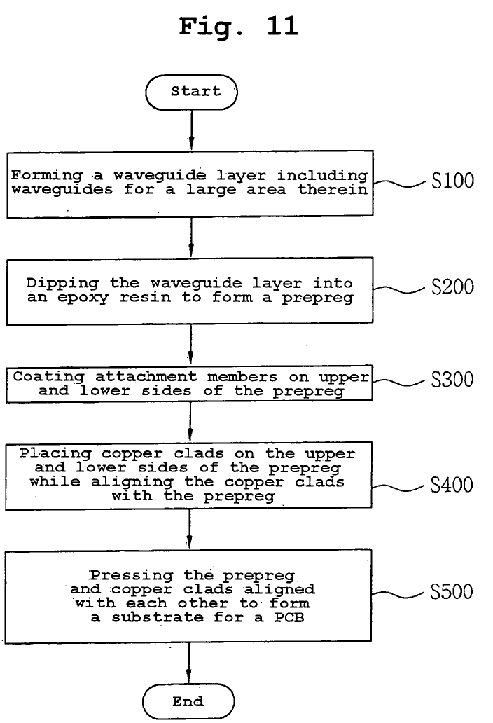

Hereinafter, a detailed description will be given of the production of the PCB including the waveguides embedded therein, according to the third embodiment of the present invention, by reference to FIGS. 11 to 13I.

The waveguide layer 300 including the waveguides 140 to transmit an optical signal therethrough are formed in operation 100.

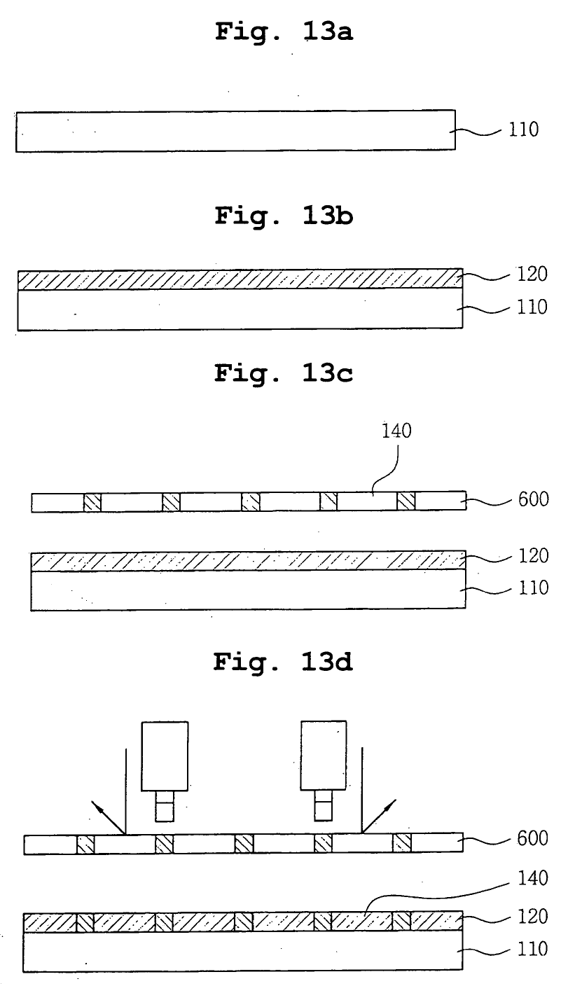

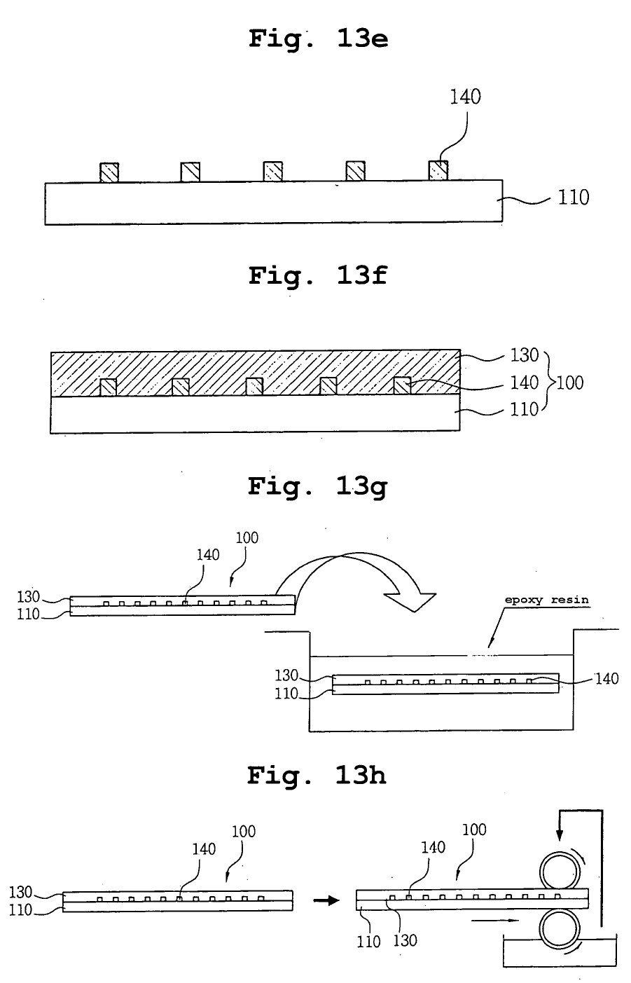

In detail, as shown in FIG. 13A, the lower clad layer 110 is formed to conduct the total-reflection of the optical signal in operation 101.

Referring to FIG. 13B, the core layer 120, which will form the waveguides 140 with a predetermined shape for the large area, is coated on the lower clad layer 110 in operation 102, and as shown in FIG. 13C, an exposing film 600 on which a waveguide pattern with a predetermined shape is formed is aligned with the core layer 120 in operation 103.

With reference to FIG. 13D, the core layer 120 is exposed to UV (ultraviolet rays) through the exposing film on which the waveguide pattern is formed in operation 104.

As shown in FIG. 13E, a portion of the core layer 120 is removed, which occupies a volume except for the other portion of the core layer 120 exposed to the UV to be cured, to form the waveguides 140 with a predetermined shape for the large area, corresponding in shape to the waveguide pattern of the exposing film 600, from the core layer 120 in operation 105.

As shown in FIG. 13F, the upper clad layer 130 is formed on the core layer 120 on which the waveguides 140 for the large area are formed, thereby accomplishing the waveguide layer 100 including the waveguides 140 for the large area in operation 106.

Referring to FIGS. 13G and 13H, after the waveguide layer 100 including the waveguides 140 for the large area is accomplished, the waveguide layer 100 is embedded in an epoxy resin 200 according to a predetermined process to produce the prepreg 100 having a structure that the waveguide layer 100 including the waveguies 140 for the large area is embedded in the epoxy resin 200 in operation 200.

In this respect, FIG. 13G illustrates the dipping of the waveguide layer 100 into a vessel containing the epoxy resin 200.

Additionally, FIG. 13H illustrates the coating of the waveguide layer 100 with the epoxy resin 200 according to a rolling process.

After the prepreg 30b is produced, which is having a structure that the waveguide layer 100 including the waveguies 140 for the large area is embedded in the epoxy resin 200, attachment members 400 are coated on upper and lower sides of the prepreg 300 in operation 300 as shown in FIG. 13I, and the resulting structure is pressed at predetermined temperature and pressure, thereby accomplishing the PCB including the waveguides 140 for the large area, in detail, a copper clad laminate (CCL) in operation 500.

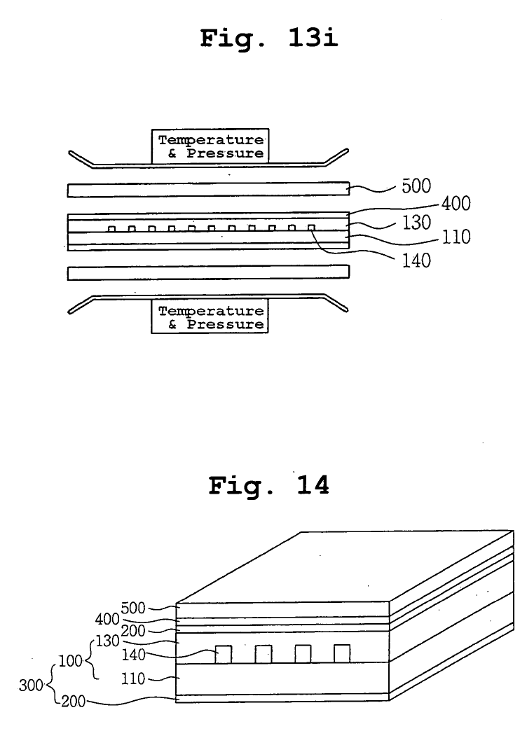

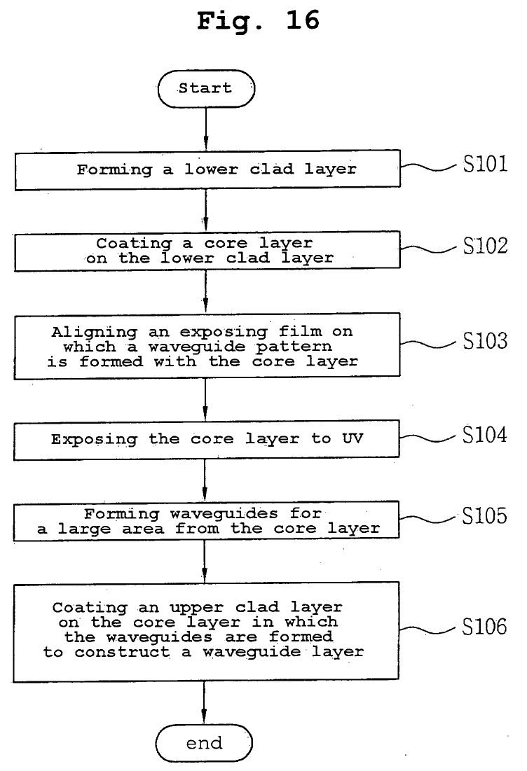

Hereinafter, a detailed description will be given of a PCB including waveguides embedded therein according to the fourth embodiment of the present invention, and a method of producing the PCB, by reference to FIGS. 14 to 17I.

The PCB with the waveguides according to the fourth embodiment of the present invention comprises a prepreg 300 including a waveguide layer 100 to transmit an optical signal therethrough and epoxy resin layers 200 coated on upper and lower sides of the waveguide layer 100, and a copper clad 500 formed on any one side of the prepreg 300 through a press process while an attachment member 400 is interposed between the epoxy resin layer 200 and the copper clad 500 as shown in FIG. 14.

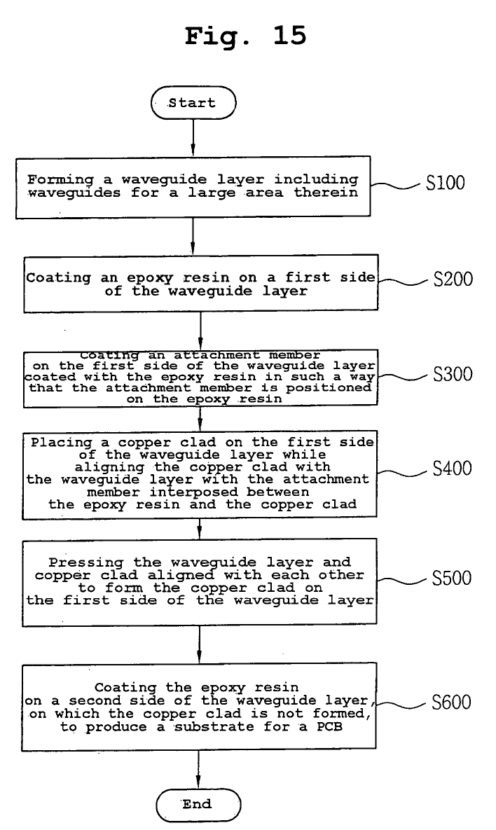

Hereinafter, a detailed description will be given of the production of the PCB including the waveguides embedded therein, according to the fourth embodiment of the present invention, by reference to FIGS. 15 to 17I.

The waveguide layer 100 including the waveguides 140 to transmit an optical signal therethrough are formed in operation 100.

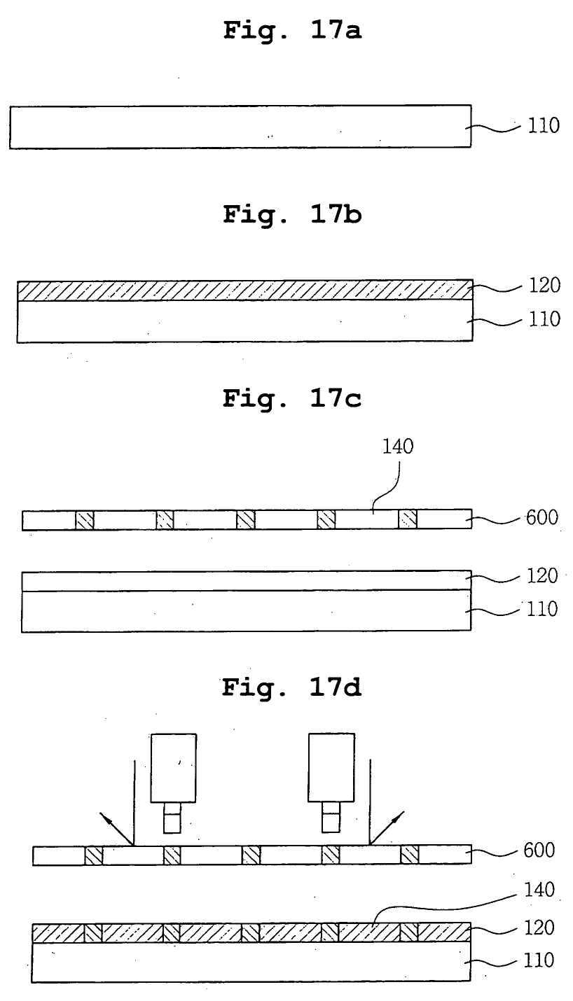

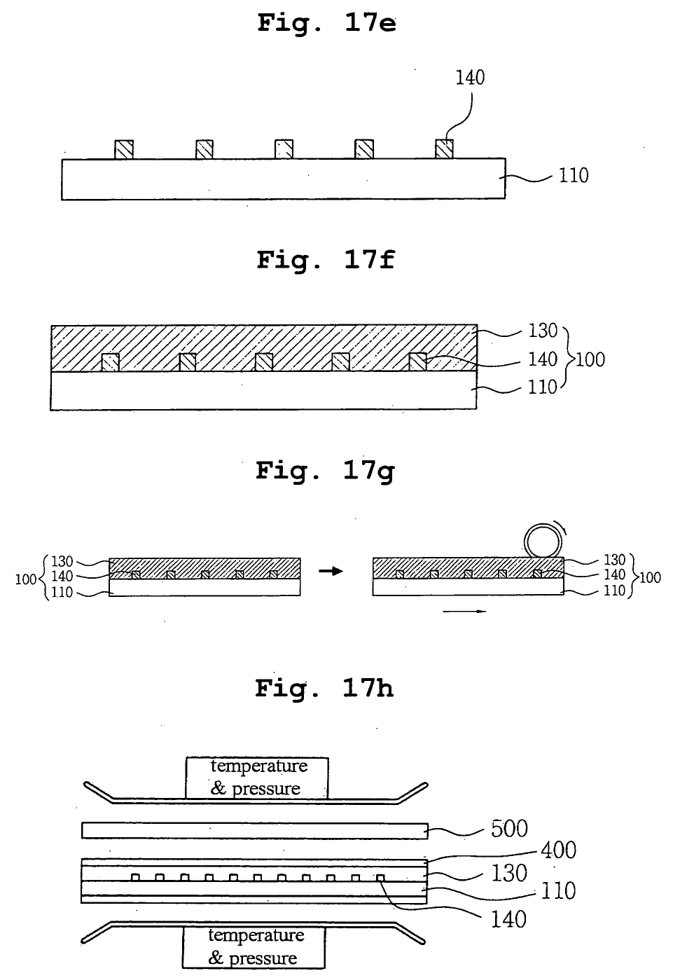

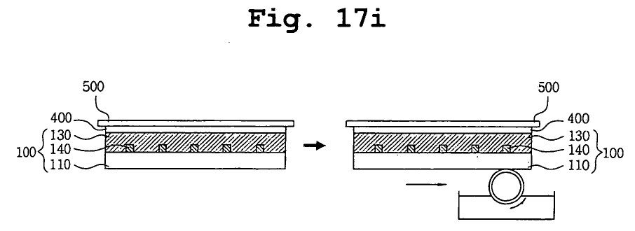

In detail, as shown in FIG. 17A, a lower clad layer 110 is formed to conduct a total-reflection of the optical signal in operation 101.

Referring to FIG. 17B, a core layer 120, which will form the waveguides 140 with a predetermined shape for a large area, is coated on the lower clad layer 110 in operation 102, and as shown in FIG. 17C, an exposing film 600 on which a waveguide pattern with a predetermined shape is formed is aligned with the core layer 120 in operation 103.

With reference to FIG. 17D, the core layer 120 is exposed to UV through the exposing film on which the waveguide pattern is formed in operation 104.

As shown in FIG. 17E, a portion of the core layer 120 is removed, which occupies a volume except for the other portion of the core layer 120 exposed to the UV to be cured, to form the waveguides 140 with a predetermined shape for the large area, corresponding in shape to the waveguide pattern of the exposing film 600, from the core layer 120 in operation 105.

As shown in FIG. 17F, after the core layer 120 is exposed to the UV to form the waveguides 140 with a predetermined shape, an upper clad layer 130 is formed on the core layer 120 on which the waveguides 140 are formed, thereby accomplishing the waveguide layer 100 including the waveguides 140 for the large area in operation 106.

Referring to FIGS. 17G, after the waveguide layer 100 including the waveguides 140 for the large area is accomplished, an epoxy resin 200 is coated on one side of the waveguide layer 100 according to a predetermined process in operation 200.

In this respect, FIG. 17G illustrates the coating of the waveguide layer 100 with the epoxy resin 200 according to a rolling process.

As shown in FIG. 17H, the attachment member 400 is coated on one side of the waveguide layer 100 coated with the epoxy resin 200 in operation 300, the waveguide layer 100 and copper clad 500 are aligned with each other using the attachment member 400 interposed between the waveguide layer 100 and the copper clad 500 in operation 400, and the resulting structure is pressed at predetermined temperature and pressure, thereby forming the copper clad 500 on one side of the waveguide layer 100 in operation 500.

As shown in FIG. 17I, the epoxy resin 200 is coated on the other side of the waveguide layer 100, on which the copper clad 500 is not coated, according to a rolling process, thereby accomplishing the PCB including the waveguides 140 for the large area, in detail, a resin-coated copper (RCC) in operation 600.

As apparent from the above description, the present invention is advantageous in that a PCB is produced using a prepreg including optical fibers or waveguides disposed therein at regular intervals, thus a process of producing the PCB is simplified, thereby the PCB including the optical fibers or the waveguides embedded therein can be produced in a commercial quantity.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A printed circuit board, comprising:
a prepreg:
wherein optical fibers disposed at regular intervals; and
an epoxy resin including the optical fibers embedded therein, and
copper clads formed on both sides of the prepreg through a press process.

2. The printed circuit board as set forth in claim 1, wherein the copper clads are formed on any one side of the prepreg through the press process.

3. A printed circuit board, comprising:
a prepreg including a waveguide layer to transmit an optical signal therethrough and an epoxy resin layer coated on the waveguide layer with an epoxy resin; and
copper clads formed on upper and lower sides of the prepreg with attachment members interposed between the prepreg and the copper clads through a press process.

4. The printed circuit board as set forth in claim 3, wherein the copper clads are formed on any one side of the prepreg with an attachment member interposed between the prepreg and the copper clad through a press process.

5. A method of producing a printed circuit board, comprising:
a first step of disposing optical fibers on fixing jigs at regular intervals;
a second step of dipping the fixing jigs including the optical fibers disposed on surfaces thereof in a vessel containing an epoxy resin to embed the optical fibers in the epoxy resin;
a third step of separating the fixing jigs from the optical fibers embedded in the epoxy resin;
a fourth step of curing the epoxy resin including the optical fibers embedded therein to produce a semicured prepreg;
a fifth step of forming copper clads on both sides of the semicured prepreg while aligning the copper clads with the semicured prepreg; and
a sixth step of pressing the semicured prepreg and copper clads aligned with each other at predetermined temperature and pressure.

6. The method as set forth in claim 5, wherein the fixing jigs including the optical fibers disposed at regular intervals on surfaces thereof are subjected to a rolling process to embed the optical fibers in the epoxy resin in the second step.

7. A method of producing a printed circuit board, comprising:
a first step of mounting fixing jigs, including optical fibers disposed at regular intervals thereon, on a copper clad;
a second step of conducting a rolling process for the fixing jigs, including optical fibers disposed at regular intervals thereon and mounted on the copper clad, to coat the optical fibers with an epoxy resin;
a third step of separating the fixing jigs from the optical fibers; and
a fourth step of semidrying the epoxy resin coated on the optical fibers to form a semicured prepreg on the copper clad.

8. A method of producing a printed circuit board, comprising:
a first step of forming a waveguide layer, including waveguides for a large area therein, to transmit an optical signal therethrough;
a second step of dipping the waveguide layer into an epoxy resin to form a semicured prepreg having a structure that the waveguide layer is embedded in the epoxy resin;
a third step of coating attachment members on upper and lower sides of the semicured prepreg;
a fourth step of placing copper clads on the upper and lower sides of the semicured prepreg while aligning the copper clads with the semicured prepreg with the attachment members interposed between the semicured prepreg and the copper clads; and
a fifth step of pressing the semicured prepreg and copper clads aligned with each other at predetermined temperature and pressure.

9. A method of producing a printed circuit board, comprising:
a first step of forming a waveguide layer, including waveguides for a large area therein, to transmit an optical signal therethrough;
a second step of conducting a first rolling process for a first side of the waveguide layer to coat the first side of the waveguide layer with an epoxy resin;
a third step of coating an attachment member on the first side of the waveguide layer coated with the epoxy resin in such a way that the attachment member is positioned on the epoxy resin;
a fourth step of placing a copper clad on the first side of the waveguide layer while aligning the copper clad with the waveguide layer with the attachment member interposed between the epoxy resin and the copper clad;
a fifth step of pressing the waveguide layer and copper clad aligned with each other at predetermined temperature and pressure; and
a sixth step of conducting a second rolling process for a second side of the waveguide layer, on which the copper clad is not formed, to coat the second side of the waveguide layer with the epoxy resin.
